(19) United States
(12) Patent Application Publication
(10) Pub. No.: US 2026/0157918 A1
(43) Pub. Date: Jun. 11, 2026

(54) HANDHELD EYELID MASSAGER

(71) Applicant: Oculab Private Limited, Palghar (IN)

(72) Inventors: Hemal KENIA, Mumbai (IN); Paras Shah, Mumbai (IN); Sanandan Sudhir, Ahmedabad (IN); Smit Modi, Ahmeciabad (IN)

(21) Appl. No.: 19/180,640

(22) Filed: Apr. 16, 2025

(30) Foreign Application Priority Data
Apr. 16, 2024 (IN) 202421030568

(51) Int. Cl. A61H 15/00

(52) U.S. Cl. CPC A61H 15/0092; A61H 2015/0014; A61H 2201/1253; A61H 2201/1676; A61H 2201/1695; A61H 2205/024

(57) ABSTRACT

An eyelid massager includes a handle having a free end, and a roller pivotally coupled thereto. The roller is dumbbell shaped having a curvature on an outer surface that matches curvature of a closed eye of the user, such that the roller makes a contact with eyelids along an entire length of the eye during a massaging action, to press a plurality of meibomian glands associated with eyelids, facilitating release of clogged oils. The handle is Y-shaped at the free end to pivotally hold the roller at two ends through a pair of inward extending pins that engage with a pair of holes provided on the roller. The roller is made of silicon rubber, and the curvature of the outer surface having a plurality of ribs.

### CROSS-REFERENCE TO RELATED APPLICATIONS

This application claims the benefit of Indian Patent Application No. 202421030568, filed on Apr. 16, 2024. The entire disclosure of the above application is incorporated herein by reference.

### TECHNICAL FIELD

The present disclosure relates generally to the field of devices for eye lubrication. More particularly, the present disclosure relates to a handheld device to massage eyelids of a user to remove clogged oil from meibomian glands of eyes to open meibomian glands.

### BACKGROUND

Background description includes information that may be useful in understanding the present invention. It is not an admission that any of the information provided herein is prior art or relevant to the presently claimed invention, or that any publication specifically or implicitly referenced is prior art.

It is common for a person to have symptoms of dry eyes during his/her middle and old age. A common cause of the dry eyes is not the lack of watery substance in the eyes, but a lack of oily substance in tears. Tears are complex mix of various liquid substances secreted by glands present in and around eyes. These liquids need to be in correct balance in order to maintain health of the eyes.

Meibomian glands are one such gland located directly above the eyes throughout upper eyelid and lower eyelid in pluralities, to secrete oily liquids that keep watery parts of the tears from evaporating. The oily liquid is secreted during each blink the eyes. It is the dysfunction of the meibomian glands that poses problem in most of the people who suffer from dry eye conditions. This may be due to the thinning of skin allowing the glands to cool quickly, leading to. The oily substance present in the meibomian glands to clog as the body heat in and around the meibomian glands is not maintained.

There are various methods to treat the condition of dry eyes, such as putting medicinal lubricating liquid regularly in the eyes, application of eye creams, taking oral pills and surgical interventions. But medication causes drug allergies, sensitivities, and also incurred cost of the medicine on regular basis. To treat the basic cause of the dry eyes, meibomian glands are required to be unclogged.

Patent Document CN209236572U discloses a dry eye treatment instrument, including shell, bracket, a pair can be bonded with human body eye socket and flexible material made of eye patch body, heating component and vibration component, the shell is mounted on bracket, the pair of eye patch body is located on bracket, it is set on bracket there are two first through hole, each eye patch body is respectively equipped with the second through hole. Each eye patch body is equipped with turn up structure extended to centre, the curved support zone of the turn up structure is the position that eye patch body are close to the eye socket on human body. The compact-sized instrument progress synchronous with vibration massage to the hot compress of Meibomian glands and affect it good, using same position, different human body eye socket can be more in line with, do not squeeze eyeball.

A known method for unclogging the meibomian glands, which does not require use of medication, is to apply warm compress to eyelids. However, often that may not be enough, and may need following it up with a massage, which may typically be done by the compress itself. However, to make the treatment more effective, it may be desirable to have a more effective and efficient device for massaging the eyelids for unclogging the meibomian glands.

There is, therefore, a need in the art to provide a device for massaging eyelids of user for treatment of dry eyes.

### OBJECTS OF THE INVENTION

A general object of the present disclosure is to provide an effective treatment for the problem of dry eyes.

An object of the present disclosure is to overcome the problem of dry eyes by ensuring adequate supply of oily substance in tears to prevent dry eyes.

An object of the present disclosure is to provide a device to unclog meibomian glands of eyelids, thereby ensuring adequate supply of oily substance in tears to prevent dry eyes.

An object of the present disclosure is to provide a device to massage eyelids to unclog the meibomian glands of eyelids.

An object of the present disclosure is to provide a, eyelid massager for massaging eyelids that is ergonomically designed, incorporates effective tactile features, is simple and easy to use and maintain.

### SUMMARY

Aspects of the present disclosure relate generally to the field of devices for eye lubrication. In particular, the present disclosure relates to a handheld device to massage eyelids to remove clogged oil from meibomian glands of eyes of a user to open the meibomian glands. More particularly, the present disclosure provides an eyelid massager for massaging eyes for the purpose of exfoliation of the meibomian glands for facilitating release of the clogged oil, thereby unclogging the meibomian glands.

In an aspect, the proposed eyelid massager includes a handle having a free end; and a roller pivotally coupled to the free end of the handle. The roller is dumbbell shaped having a curvature of an outer surface which matches with curvature of a closed eye of a user, such that the roller makes a contact with eyelids along an entire length of the eye during a massaging action and press a plurality of meibomian glands associated with eyelids, facilitating release of clogged oils.

In an embodiment, the curvature of the outer surface of the roller may be configured to enable the massaging action in a vertical direction.

In an embodiment, the handle may be Y-shaped at the free end, and the dumbbell shaped roller may be held at two ends of the roller by engagement with two ends of the Y-shaped free end.

In an embodiment, the Y-shaped free end of the handle may include a pair of inward extending pins to pivotally hold the roller.

In an embodiment, the roller may include a pair of holes located at two ends of the roller concentric to a rotational axis of the roller for engagement with the pair of pins of the handle to provide the pivotal coupling of the roller with the handle.

In an embodiment, the roller may be made of silicon rubber.

In an embodiment, the roller may include a plurality of ribs on the outer surface to create a textured surface.

In an embodiment, the ribs may be parallelly placed along a rotational axis of the roller.

In an embodiment, the handle may include one or more ribbed surfaces for the user to grip the handle.

Another aspect of the disclosure is a method for eye massaging including steps for providing an eyelid massager including a handle having a free end; and a roller pivotally coupled to the free end of the handle. The roller having a dumbbell shape with a curvature of an outer surface of the roller matching with curvature of a closed eye of a user; placing roller of the massager over the uppermost part of closed eyelids of an eye; and pressing the roller mildly and rolling vertically down to press a plurality of meibomian glands associated with the eyelids.

In an embodiment, placing the roller of the massager over the uppermost part of closed eyelids of the eye and pressing the roller mildly and rolling vertically down till the plurality of clogged meibomian glands are open to release clogged oil.

In an embodiment, wiping the released oil from the plurality of meibomian glands to clear edge of the eyelids.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1A illustrates an exemplary perspective view from top of the proposed handheld eyelid massager, in accordance with embodiments of the present disclosure.

FIG. 1B illustrates an exemplary perspective view from bottom of the handheld eyelid massager, in accordance with embodiments of the present disclosure.

FIG. 2A illustrates an exemplary perspective view of a handle of the handheld eyelid massager, in accordance with embodiments of the present disclosure.

FIG. 2B illustrates an exemplary perspective view of a roller of the handheld eyelid massager, in accordance with embodiments of the present disclosure.

FIG. 3 illustrates an exemplary view showing application of the handheld eyelid massager for performing massaging of eyelids, in accordance with embodiments of the present disclosure.

FIG. 4 illustrates an exemplary method diagram for performing massaging of eyelids, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments explained herein relate generally to the field of ophthalmology. More particularly, they relate to a handheld device to massage eyelids to remove clogged oil from meibomian glands to open the glands allow the glands to secrete oil that is essential to keep the eyes free from dry eye condition. As known, the meibomian glands secrete oil (lipid) and spread over the edge of both upper and lower eyelids. The upper eyelid includes about 30 to 40 glands and lower eyelid has 20 to 30 glands. When the meibomian glands stop secreting oil, eyes experience a condition known as dry eye condition, or meibomian glands dysfunction (MGD). The MGD may be is caused by several microbial, hormonal, metabolic, ageing, and environmental factors, and if not treated, may invite one or more eye diseases. Topical lubricants are administered to relieve symptoms, reduce tear film evaporation and stabilise oil in tear film. Often, MGD may be due to clogging of the meibomian glands, a massaging action can help to unclog the glands and cure the dry eye condition.

In an embodiment, the present disclosure provides an eyelid massager that includes a handle and a roller pivotally coupled to a free end of the handle. The roller is dumbbell shaped with a curvature of an outer surface that matches curvature of a closed eye of a user, such that during a massaging action, the roller makes a contact with eyelids along an entire length of eyelids to press a plurality of meibomian glands associated with eyelids, facilitating release of clogged oils.

In an embodiment, the handle is Y-shaped at the free end to pivotally hold the roller at two ends of the roller with a pair of inward extending pins that engage with corresponding holes in the roller.

In an embodiment, the roller is made of silicon rubber, and the curvature of the outer surface of the roller includes a plurality of ribs to create a textures surface. The ribs are parallelly placed along a rotational axis of the roller

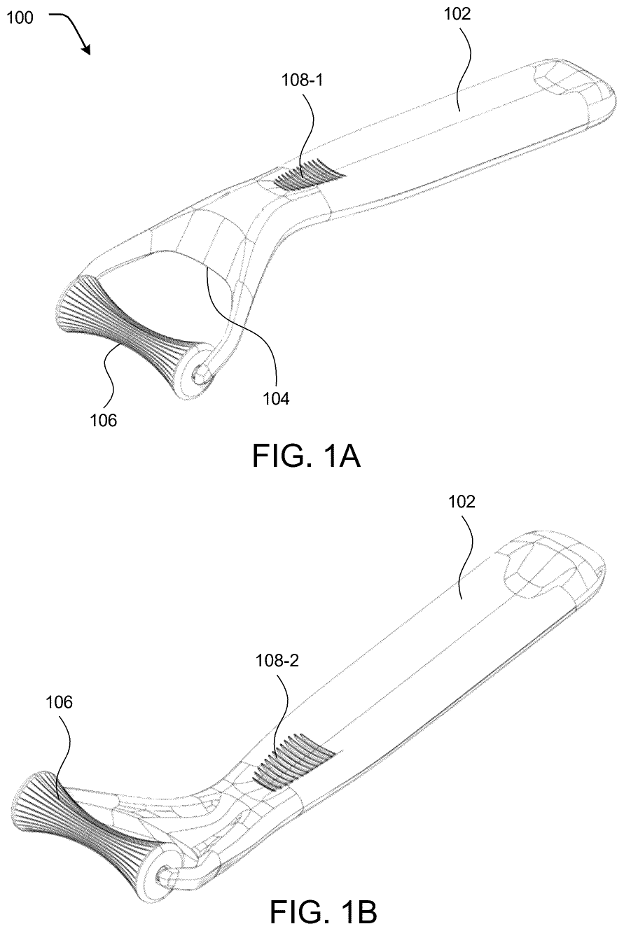

Referring now to FIGS. 1A and 1B, where perspective views from top and bottom sides of the proposed handheld eyelid massager are shown, the handheld eyelid massager 100 can include a handle 102 having a free end 104, and a roller 106 pivotally coupled to the free end 104 of the handle 102.

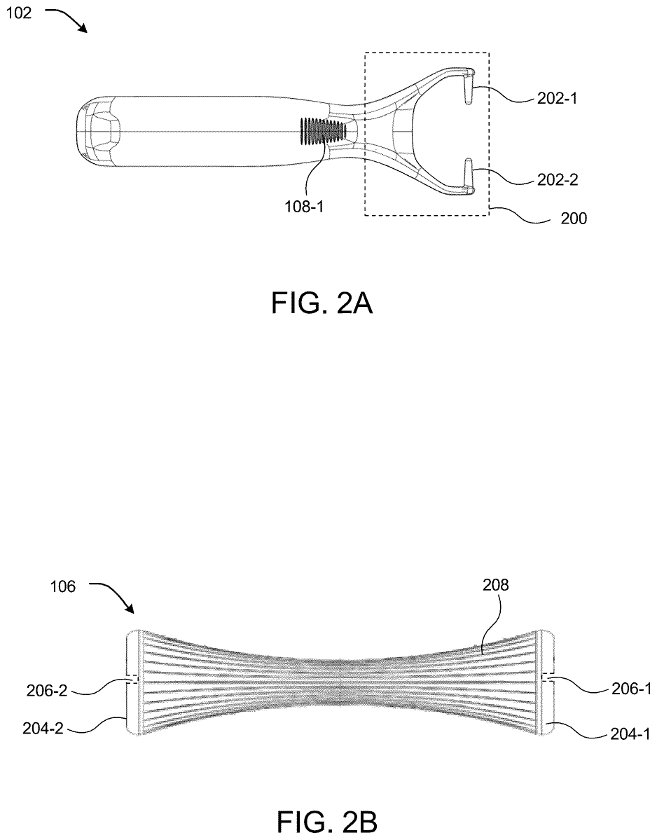

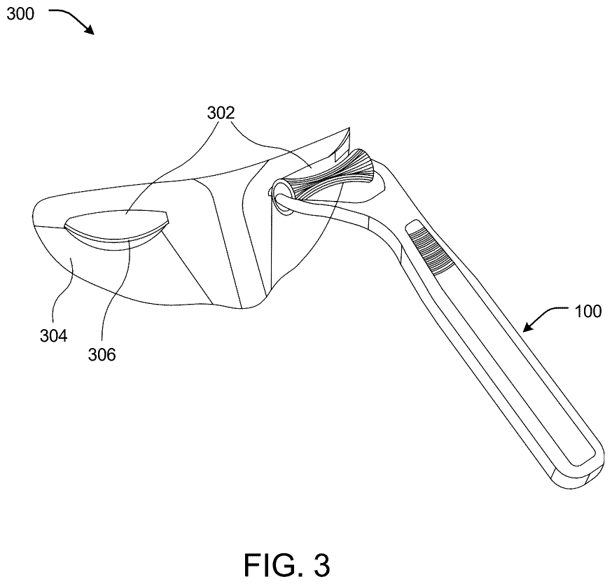

In an embodiment, the roller 106 can be pivotally coupled to the handle 102 through a pair of pins 202-1 and 202-2 (refer FIG. 2A) provided on the handle 102. The roller 106 can be dumbbell shaped having a curvature of an outer surface that matches curvature of a closed eye 302 (refer to FIG. 3) of a user 304 (refer to FIG. 3), such that the roller 106 makes a contact with eyelids along an entire length of eyelids, during a massaging action to press all of a plurality of meibomian glands located on the eyelids, and facilitate release of clogged oils.

In an embodiment, the handle can include one or more ribbed surfaces 108, such as an upper ribbed surface 108-1 at a location where the handle 102 is gripped by thumb of the user, and a lower ribbed surface 108-2 (FIG. 1B) on lower surface of the handle 102, where remaining fingers hold the handle 102. The ribbed surfaces 108 can help in providing a better grip over the handle 102 and do not allow handle 102 to slip.

As shown in FIG. 2A, the handle can be Y-shaped 200 at the free end 104 to pivotally hold the dumbbell shaped roller 106 at two ends 204-1 and 204-2 (collectively referred to as ends 204, herein) of the roller 106. The Y-shaped 200 free end 104 of the handle 102 includes a pair of inward extending pins, such as pins 202-1 and 202-2 (collectively referred to as pins 202, herein), to pivotally hold the roller 106.

In an embodiment, the Y-shaped portion 200 of the handle 102 at the free end 104 is bent downward to position the rotational axis of the roller 106 below an axis of the handle 102. This feature provides filling the natural depth of the eyes and better hold on the contours of the eye area. The massager 100 can be comfortably held by the user keeping the user's hand straight, eliminating any potential discomfort.

As shown in FIG. 2B, the roller 106 includes a plurality of ribs 208 on the outer surface to create a textured surface. The ribs 208 are parallelly placed along a rotational axis of the roller 106. The ergonomically structured outer surface ribs 208 incorporate specialised texture is optimising grip and also contribute to a precise and effective massaging.

In an embodiment, the roller 106 includes a pair of holes, such as holes 206-1 and 206-2 (collectively referred to as holes 206, herein), located at two ends 204-1 and 204-2 respectively, of the roller 106. The two holes 206-1 and 206-2 define the rotational axis of the roller 106 and are concentric to a longitudinal axis of the dumbbell shaped roller 106. The pair of pins 202-1 and 202-2 of the handle 102 can engage with the holes 206-1 and 206-2 to provide the pivotal coupling of the roller 106 with the handle 102. The dumbbell shape of the roller 106 is configured to match curvature of the eyes to ensure a full contact between the eyelids and the roller to guide the flow of the massage during use.

In an embodiment, the curvature of the outer surface of the roller 106 is configured to enable the massaging action in a vertical direction, i.e., from the upper eyelid to the lower eyelid and vice-versa, as shown in FIG. 3. While moving in the above manner, the roller 106 moves over edges of the eyelids, where the glands are located, and gently press the glands to squeeze out the clogged oil.

In an embodiment, the roller 106 can be made of silicon rubber. The resilient nature of the material can take care of any mismatch between the eyelids and the roller 106. The soft contacts of the ribbed surface of the silicon roller 106 avoid any potential for harsh rubbing with the skin of the eyelids.

In an aspect, before undertaking massage, the area of eyelids 306 may be subjected to warmth using at least one source of heat selected from a kind of radiation, heat pad, putting pad soaked with lukewarm water, at least for five minutes. Exposure of eyes to heat allows loosening of accumulated and clogged oil within the meibomian glands, such that the loosened oil becomes more amenable to removal by the massaging action.

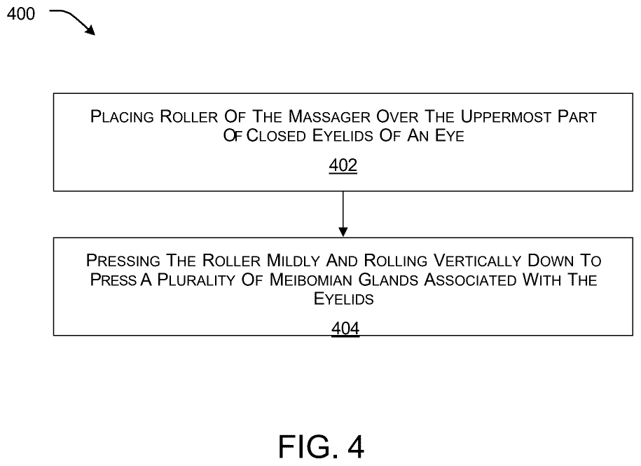

FIG. 4 illustrates an exemplary method diagram 400 for performing massaging of eyelids 106. Another aspect of the disclosure is a method 400 for eye massaging including steps for providing an eyelid massager 100 including a handle 102 having a free end 104; and a roller 106 pivotally coupled to the free end 104 of the handle 102. The roller 106 having a dumbbell shape with a curvature of an outer surface of the roller 106 matching with curvature of a closed eye 302 of a user 304; according to step 402, placing roller 106 of the massager 100 over the uppermost part of closed eyelids 306 of an eye 302; and as per step 404, pressing the roller 106 mildly and rolling vertically down to press a plurality of meibomian glands associated with the eyelids 306.

In an embodiment, placing the roller 106 of the massager 100 over the uppermost part of closed eyelids 306 of the eye 302 and pressing the roller 106 mildly and rolling vertically down till the plurality of clogged meibomian glands are open to release clogged oil.

In an embodiment, wiping the released oil from the plurality of meibomian glands to clear edge of the eyelids 306

In an embodiment, an unskilled person may use the massager 100 for compressing the eyelids 306 to open clogged meibomian glands, which eliminates the use of commonly required forceps designed device used to do so.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### ADVANTAGES OF THE INVENTION

The present disclosure provides an effective treatment for the problem of dry eyes.

The present disclosure overcomes the problem of dry eyes by ensuring adequate supply of oily substance in tears to prevent dry eyes.

The present disclosure provides a device to unclog meibomian glands of eyelids, thereby ensuring adequate supply of oily substance in tears to prevent dry eyes.

The present disclosure provides a device to massage eyelids to unclog the meibomian glands of eyelids.

The present disclosure provides a, eyelid massager for massaging eyelids that is ergonomically designed, incorporates effective tactile features, is simple and easy to use and maintain.

We claim:

1. An eyelid massager comprising:
a handle having a free end; and
a roller pivotally coupled to the free end of the handle;
wherein the roller is dumbbell shaped having a curvature of an outer surface of the roller matching with curvature of a closed eye of the user, such that the roller makes a contact with eyelids along an entire length of the eye during a massaging action to press a plurality of meibomian glands associated with eyelids, facilitating release of clogged oils.

2. The eyelid massager as claimed in claim 1, wherein the curvature of the outer surface of the roller is configured to enable the massaging action in a vertical direction.

3. The eyelid massager as claimed in claim 1, wherein the handle is Y-shaped at the free end to pivotally hold the dumbbell shaped roller at two ends of the roller.

4. The eyelid massager as claimed in claim 3, wherein the Y-shaped free end of the handle comprises a pair of inward extending pins to pivotally hold the roller.

5. The eyelid massager as claimed in claim 4, wherein the roller comprises a pair of holes located at two ends of the roller concentric to a rotational axis of the roller for engagement with the pair of pins of the handle to provide the pivotal coupling of the roller with the handle.

6. The eyelid massager as claimed in claim 1, wherein the roller is made of silicon rubber.

7. The eyelid massager as claimed in claim 1, wherein the roller comprises a plurality of ribs on the outer surface to create a textures surface.

8. The eyelid massager as claimed in claim 7, wherein the plurality of ribs are parallelly placed along a rotational axis of the roller.

9. The eyelid massager as claimed in claim 1, wherein the handle comprises one or more ribbed surfaces for the user to grip the handle.

10. A method for eye massaging, the method comprising steps for:
providing an eyelid massager, the eyelid massager comprising:
a handle having a free end; and
a roller pivotally coupled to the free end of the handle; the roller having a dumbbell shape with a curvature of an outer surface of the roller matching with curvature of a closed eye of a user:
placing the roller of the eyelid massager over an uppermost part of closed eyelids of an eye; and
pressing the roller mildly and rolling vertically down to press a plurality of meibomian glands associated with the eyelids.

11. The method as claimed in claim 10, comprising the step of repeating the steps of placing the roller of the massager over the uppermost part of closed eyelids of the eye and pressing the roller mildly and rolling vertically down until the plurality of clogged meibomian glands are open to release clogged oil.

12. The method as claimed in claim 11, comprising the step of wiping the released oil from the plurality of meibomian glands to clear edge of the eyelids.
